(19) United States
(12) Patent Application Publication
(10) Pub. No.: US 2017/0148037 A1
(43) Pub. Date: May 25, 2017

(54) METHOD AND SYSTEM FOR COMPUTING PRICE-EFFICIENCY RATING FOR A MERCHANT

(71) Applicant: Mastercard International Incorporated, Purchase, NY (US)

(72) Inventors: Shuvam Sengupta, Gurgaon (IN); Rohit Modi, New Delhi (IN); Pulkit Gupta, New Delhi (IN); Ankur Arora, New Delhi (IN)

(21) Appl. No.: 15/361,197

(22) Filed: Nov. 25, 2016

(30) Foreign Application Priority Data
Nov. 25, 2015 (SG) 10201509688U

(51) Int. Cl. G06Q 30/02

(52) U.S. Cl. CPC G06Q 30/0201; G06Q 30/0241

(57) ABSTRACT

A computer-implemented method for computing a price-sensitivity score for a product for sale is provided. The method comprises (a) receiving, by a transaction analysis component, transaction data comprising a purchase of the target product by a consumer; (b) receiving, by a product analysis component, a reference price-sensitivity score for a reference product for sale; (c) calculating, by the transaction analysis component, a correlation index using the transaction data; said correlation index being indicative a correlation between purchases of the target product and the reference product; and (d) calculating, by the product analysis component, the price-sensitivity score for the target product using the correlation index and the reference price-sensitivity score. Methods for computing a price-sensitivity rating of a consumer and a price-efficiency rating for a merchant are also provided. An apparatus for carrying out the method is also provided.

### FIELD AND BACKGROUND

This invention relates to a method and apparatus for computing a price-sensitivity score for a product for sale. In particular, it provides a method and apparatus for analysing a degree to which the product is price-sensitive.

Price sensitivity refers to the degree to which the price of a product affects consumers (i.e. human subjects) purchasing behaviour. Some consumers may be more price sensitive than others. For example, consumers who are more frugal or of a mid- or low-income level are more likely to shop around for lower prices or greater values; while some high-income level consumers may feel it is not always worth their time to search for better deals on many items and thus become less price sensitive. The degree of price sensitivity may also vary from product to product, including within a same category of products of different brands. For example, in India, a Lifebuoy brand bar soup (which is often bought by price-sensitive consumers) is considered to have a higher price sensitivity than, for example, a Dove brand Soap (which is more often bought by upmarket or less price-sensitive consumers). Understanding price-sensitivity of each consumer and/or product is important. For retail merchants, this information helps optimize pricing and promotions, allows for better product assortments, and enhances consumer communication and loyalty.

The existing ways of analysing price sensitivity or elasticity uses statistical models by estimating a demand curve of a product. This requires accurate information on product price, price of substitute and complement products, promotions, seasonality, as well as macro-economic factors such as income levels, etc. However, such information is not always available or accurate which may lead to inaccurate elasticity estimation. Sometimes, the various information needs to be acquired at a high price from one or more third party data vendors. Also, frequent price fluctuations due to promotions, stock related issues, store level pricing and the like further complicate the accurate price sensitivity estimations.

Therefore, it is desirable to have an improved method for estimating price-sensitivity scores for products and/or consumers.

### SUMMARY OF INVENTION

The present disclosure aims to provide a reliable and simplified way of computing a price-sensitivity score for products, a price-sensitivity rating of a consumer and a price-efficiency rating for a merchant, utilizing consumers' perception towards the products which is reflected by their purchasing behaviour. For example, this can be readily computed using transaction data such as stock keeping unit (SKU) level transaction data. Typically, the SKU transaction data includes one or more of the following: transaction key, store name, store location, individual key, store ID, date of purchase, time of purchase, basket ID, basket total spend, total number of items purchased, number of each product purchased, product codes, product descriptions, individual product prices, any discounts or offers redeemed etc. In other words, an estimation of price-sensitivity of a product does not require analysis of numerous specific factors required for estimating a demand curve of the product, which are conventionally used for price-sensitivity estimation. In addition, the method makes it possible to have the price sensitivity estimated at an individual consumer's level.

In general terms, the present invention proposes using transaction level data describing purchases made by consumers to analyse associations between different products of a purchase, between products of purchases by individual consumers, and/or between the individual consumers and the merchants with which the transactions were carried out, for example, a correlation in purchasing events of different products. Such associations are analysed to extract relevant price-sensitivity information.

According to a first expression, there is provided computer-implemented method for computing a price-sensitivity score for a target product for sale. The method comprises operations of:
(a) receiving, by a transaction analysis component, transaction data comprising a purchase of the target product by a consumer;
(b) receiving, by a product analysis component, a reference price-sensitivity score for a reference product for sale;
(c) calculating, by the transaction analysis component, a correlation index using the transaction data; said correlation index being indicative a correlation between purchases of the target product and the reference product; and
(d) calculating, by the product analysis component, the price-sensitivity score for the target product using the correlation index and the reference price-sensitivity score.

The use of transaction data describing past purchases of products allows a price-sensitivity score of a target product to be deduced from another product (e.g. the reference product) whose price-sensitivity score is known. This deduction utilizes the purchasing behaviours exhibited by the consumers, and is based on the assumption that a consumer who is sensitive to price more often tends to buy products that are price-sensitive (or price-efficient), and vice versa. Therefore, it allows the price-sensitivity score for products to be readily obtained without requiring extensively collecting and studying price information/fluctuations and other factors (which will be required conventionally for price-sensitivity estimation) for each product.

In some embodiments, the database comprises transaction data in respect of transactions carried out over a payment network by the consumer. Alternatively or additionally, the database may comprise transaction data for transactions carried out using other channels, such as by cash.

In some embodiments, the correlation index is indicative of a number of transactions in which the reference product and the target product are purchased in a single transaction. The correlation index may be indicative of a frequency of transactions in which the reference product and the target product are purchased in a single transaction. In another example, the correlation index is indicative of a likelihood of the reference product and the target product being purchased by a same consumer. In other words, the correlation index may reflect how often the two products are brought together. This helps to closely encapsulate the consumers' behaviour as a reflection of their perception on price-sensitivity (or price-efficiency) of different products.

In some embodiments, the correlation index is indicative of a likelihood of the reference product and the target product being respectively purchased in related transactions. The related transactions are transactions associated with a common product. Typically, the related transactions are a collection of two or more transactions in which each transaction is linked to at least one of other transactions by a common product in the respective transaction data. In other words, two transactions can be linked directly, or indirectly linked by another one or more transactions.

In one particular example, the related transactions comprise purchases of a same product.

In some embodiments, the reference product and the target product are associated with different product categories. For example, the reference product is a diary product, which belongs to the “food” product category, while the target product is a soap bar, which typically belongs to “personal care” product category. Such products may be offered by the same store or the same category of store—the supermarket in the above example. In another example, such products may be products typically offered by stores of different retail sectors or categories. In a particular example, the reference product may be food and the target product is apparel, which may be sold by grocery stores and department stores respectively. This allows for price-sensitivity of one product in one product category to be estimated based on that of a product in a different product category. In other words, this allows products across different product categories (or even different retail sectors) to be estimated easily, without requiring considering additional information specific to the respective categories or retail sectors.

According to a second expression, there is provided a computer-implemented method for classifying products for sale based on their price-sensitivities. The method comprises operations of:
(a) receiving, by a product analysis component, an initial seed list defining one or more reference products representing products corresponding to a first price-sensitivity group; and
   (b) for each of the one or more reference products:
   (i) receiving, by a transaction analysis component, transaction data from a database, said transaction data comprising a purchase of the reference product, the transaction data comprising one or more candidate products purchased with the reference product;
   (ii) calculating, by the transaction analysis component, a correlation index using the transaction data, said correlation index being indicative of a correlation between purchases of the reference product and the respective candidate product;
   (iii) determining, by the transaction analysis component, if the correlation index associated with the respective candidate product is above a pre-determined threshold; and
   (iv) if the determination is positive, classifying, by the transaction analysis component, the candidate product to the first price-sensitivity group.

In some embodiments, the method comprises forming an updated seed list containing the one or more candidate products for which the determination of sub-operation (iii) is positive, the method further comprises iteratively performing operations (a) and (b) using the updated seed list in place of the initial seed list to classify further candidate products. For example, the sub-operation (ii) in each iteration may comprise calculating the correlation index further using a corresponding weight factor; said weight factor being associated with a number of iterations performed. The weight factor may be set to decrease as the number of iterations increases. This accounts for the diminished association perceived between a candidate product that is identified after a number of iterations and the initial reference product.

In some embodiments, the method may comprise modifying a value of the pre-determined threshold based on a number of iterations performed.

In some embodiments, the reference product and the candidate product are associated with different retail sectors.

According to a third expression, there is provided a computer-implemented method for computing a price-sensitivity rating for a consumer, the method comprising operations of:
(a) receiving, by a transaction analysis component, transaction data representing a past transaction performed by a consumer, said transaction data comprising one or more products of a purchase;
(b) receiving, by a product analysis component, price-sensitivity data associated with the one or more products; and
(c) calculating, by the transaction analysis component, a price-sensitivity rating for the consumer using the price-sensitivity data; said price-sensitivity rating being indicative of a price-sensitivity level of the consumer.

The method allows for individual consumers' price-sensitivity levels to be estimated based on transaction data comprising past history of their purchases.

The method may further comprise generating and transmitting targeted offers and/or advertisement material to the consumer based on the price-sensitivity rating of the consumer, the target offers and advertisement material comprising one or more products selected based on the price-sensitivity rating.

In some embodiments, the price-sensitivity data comprises a price-sensitivity score of the product obtained by a method described above. In one example, the price-sensitivity data comprises a price-sensitivity group associated with the product obtained by a method described above.

According to a fourth expression, there is provided a computer-implemented method for computing a price-efficiency rating for a merchant, the method comprising operations of:
(a) receiving, by a transaction analysis component, transaction data representing past transactions performed by a plurality of consumers with a merchant;
(b) receiving, by a consumer analysis component, a price-sensitivity sensitivity rating associated with the each of the plurality of consumers; and
(c) calculating, by the transaction analysis component, a price-efficiency rating for the merchant using the price-sensitivity data; said price-efficiency rating being indicative of a price-efficiency level of the merchant in respect of goods for sale or service for hire.

The method allows for merchants' price-efficiency level to be estimated based on transaction data comprising the price-sensitivity profiles of consumers who made past purchases from the merchants.

The method may further comprise:
(d) obtaining a price-efficiency rating for each of a plurality of merchants;
(e) selecting a subset of the plurality of merchants based on the respective price-efficiency ratings; and
(f) generating and transmitting offers and/or advertisement material associate with the subset of merchants.

In some embodiments, the operation (f) comprise transmitting the offers and/or advertisement material to a subset of the plurality of consumers. This allows offers and/or advertisement material of selected merchants who are likely to be perceived by a customer as having a similar price-efficiency level to a merchant from who the consumer has made purchases before. In other words, it is predicted that the price-efficiency levels of the selected merchants are compatible with the price-sensitivity of the consumer, and therefore advertising efficiency is expected to be enhanced.

The subset of merchants may comprise merchants associated with different retail sectors.

In some embodiments, the subset of merchants comprises a retailer for goods and a retailer for service.

The price-sensitivity rating may be obtained by any of the methods described above.

The invention may further be expressed as an apparatus for performing any one of the above methods, said apparatus comprising: a computer processor and a data storage device, the data storage device having a transaction analysis component and a product analysis component comprising non-transitory instructions operative by the processor to perform any one of the methods described above.

The invention may further be expressed as a non-transitory computer-readable medium for performing any one of the above methods, the computer-readable medium having stored thereon program instructions for causing at least one processor to perform any one of the methods described above.

### BRIEF DESCRIPTION OF THE DRAWINGS

Embodiments of the invention will now be described for the sake of non-limiting example only, with reference to the following drawings in which:

FIG. 1 is a flow diagram of a method according to an embodiment;

FIG. 2 is a block diagram illustrating a system according to an embodiment;

FIG. 3(a) and FIG. 3(b) illustrate another embodiment, in which FIG. 3(a) schematically illustrates the method and FIG. 3(b) is a flow diagram of the method.

### DETAILED DESCRIPTION

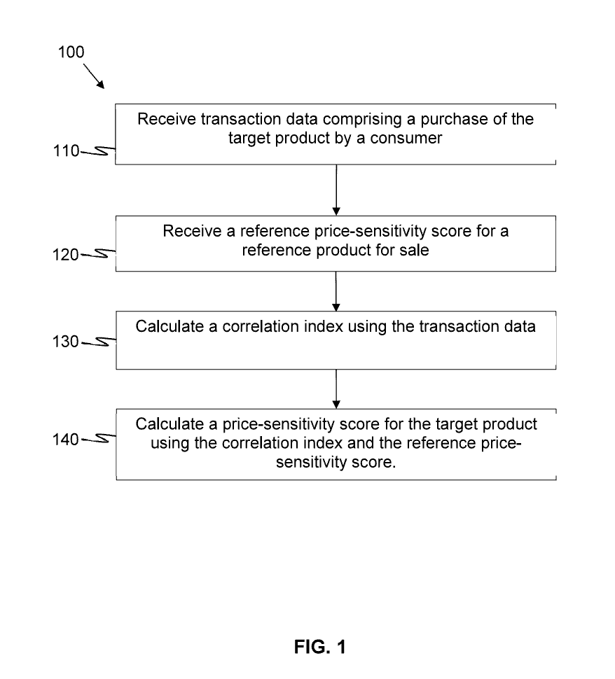

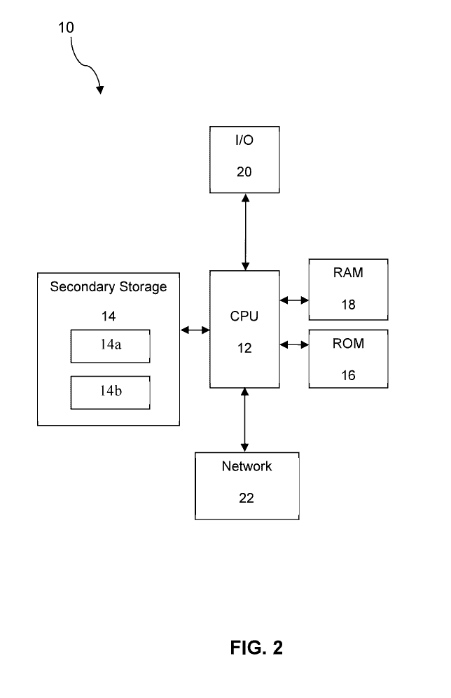

FIG. 1 shows an exemplary method 100 for calculating a price-sensitivity score for a product for sale. The price-sensitivity score is indicative of how price-efficient the product is as perceived by the consumers or how likely it is or will be purchased by price-sensitive consumers. The method 100 may be implemented by a computer having a data-processing unit. The block diagram as shown FIG. 2 illustrates a technical architecture 10 of a computer which is suitable for implementing one or more embodiments herein.

The technical architecture 10 includes a processor 12 (which may be referred to as a central processor unit or CPU) that is in communication with memory devices including secondary storage 14 (such as disk drives), read only memory (ROM) 16, random access memory (RAM) 18. The processor 12 may be implemented as one or more CPU chips. The technical architecture 12 may further comprise input/output (I/O) devices 20, and network connectivity devices 22.

The secondary storage 14 is typically comprised of one or more disk drives or tape drives and is used for non-volatile storage of data and as an over-flow data storage device if RAM 18 is not large enough to hold all working data. Secondary storage 14 may be used to store programs which are loaded into RAM 18 when such programs are selected for execution. In this embodiment, the secondary storage 14 has a product analysis component 14a a transaction analysis component 14b comprising non-transitory instructions operative by the processor 12 to perform various operations of the method of the present disclosure. The ROM 16 is used to store instructions and perhaps data which are read during program execution. The secondary storage 14, the RAM 18, and/or the ROM 16 may be referred to in some contexts as computer readable storage media and/or non-transitory computer readable media.

I/O devices 20 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 22 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 22 may enable the processor 12 to communicate with the Internet or one or more intranets. With such a network connection, it is contemplated that the processor 12 might receive information from the network, or might output information to the network in the course of performing the above-described method operations. Such information, which is often represented as a sequence of instructions to be executed using processor 12, may be received from and outputted to the network, for example, in the form of a computer data signal embodied in a carrier wave.

The processor 12 executes instructions, codes, computer programs, scripts which it accesses from hard disk, floppy disk, optical disk (these various disk based systems may all be considered secondary storage 14), flash drive, ROM 16, RAM 18, or the network connectivity devices 22. While only one processor 12 is shown, multiple processors may be present. Thus, while instructions may be discussed as executed by a processor, the instructions may be executed simultaneously, serially, or otherwise executed by one or multiple processors.

Although the technical architecture 10 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 10 to provide the functionality of a number of servers that is not directly bound to the number of computers in the technical architecture 10. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 10, at least one of the CPU 12, the RAM 18, and the ROM 16 are changed, transforming the technical architecture 10 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operation of the exemplary method 100 will now be described with reference to FIGS. 1 and 2. It should be noted that enumeration of operations is for purposes of clarity and that the operations need not be performed in the order implied by the enumeration.

At step 110, the transaction analysis component 14b receives transaction data from a database. The database may be stored by the technical architecture 10 or stored elsewhere but made accessible to the CPU 12, for example via the network device 22.

At step 120, the product analysis component 14a receives a reference price-sensitivity score for a reference product for sale. The reference product has a known reference price-sensitivity score.

In this example, the transaction data further includes a purchase of the reference product made by a consumer. According to a particular example, the transaction data comprises purchases of the reference product and the target product made in a single transaction (i.e. a “basket”). The purchase may further include other products purchased with the reference product by the consumer. The transaction data may further include such purchases of made by a plurality of consumers.

In a further example, the transaction data includes purchases of the target product and the reference product by a same consumer in different respective transactions. Purchases made by a same consumer may be identified by, for example, the payment devices (such as credit cards or a mobile wallet) and/or a loyalty/membership card the consumer uses for the transaction. The different transactions may be associated with the same or different merchants. In a further variant, the different merchants are associated with different retail sectors.

In some embodiments, the transaction data represents past transactions performed by consumers with a merchant via a payment network. The payment network may be any electronic payment network which connects, directly and/or indirectly payers (the consumer and/or their banks or similar financial institutions) with payees (the merchant and/or their banks or similar financial institutions). Non-limiting examples of the payment network are a payment card type of network such as the payment processing network operated by MasterCard, Inc., mobile telephone payment networks and the like (it should be noted that the primary purpose of the payment network may not be payment; for example, a mobile telephony network may offer payment network capability even though its primary purpose may be mobile telephony).

The transaction data may alternatively or additional include transactions carried out via other channels or ways, such as by cash, vouchers and/or coupons.

At step 130, the transaction analysis component 14b calculates a correlation index using the transaction data, said correlation index being indicative of a correlation between purchases of the reference product and the target product. The correlation index is indicative of a number of transactions in which the reference product and the target product are purchased together in a single transaction. In another example, the correlation index is indicative of a frequency of transactions in which the reference product and the target product are purchased together in a single transaction, for example, among other transactions which includes at least one of the reference product and candidate product. In yet another example, the correlation index is indicative of likelihood (such as a number or frequency) of the reference product and the target product being purchased by a same consumer, for example, even if they are purchased in different transactions.

In some embodiments, the correlation index is indicative of a likelihood of the reference product and the target product being respectively purchased in related transactions. The related transactions are transactions associated with a common product. Typically, the related transactions are a collection of two or more transactions in which each transaction is linked to at least one of other transactions by a common product in the respective transaction data. For example, if both transactions for baskets A and B comprises product X, then the two transactions are related. For another example, if the transaction for a basket A comprises products X, Y and Z whereas the transaction for a basket B comprises products Q, R, S, then they may be considered as related transactions if there is a transaction for a basket C which comprises both products X and Q, or Y and Q, etc. In other words, two transactions can be linked directly, or indirectly linked by another one or more transactions.

At step 140, the product analysis component 14a calculates a price-sensitivity score for the target product using the correlation index and the reference price-sensitivity score. For example, the price-sensitivity score for the target product may be a product of the correlation index and the reference price-sensitivity score.

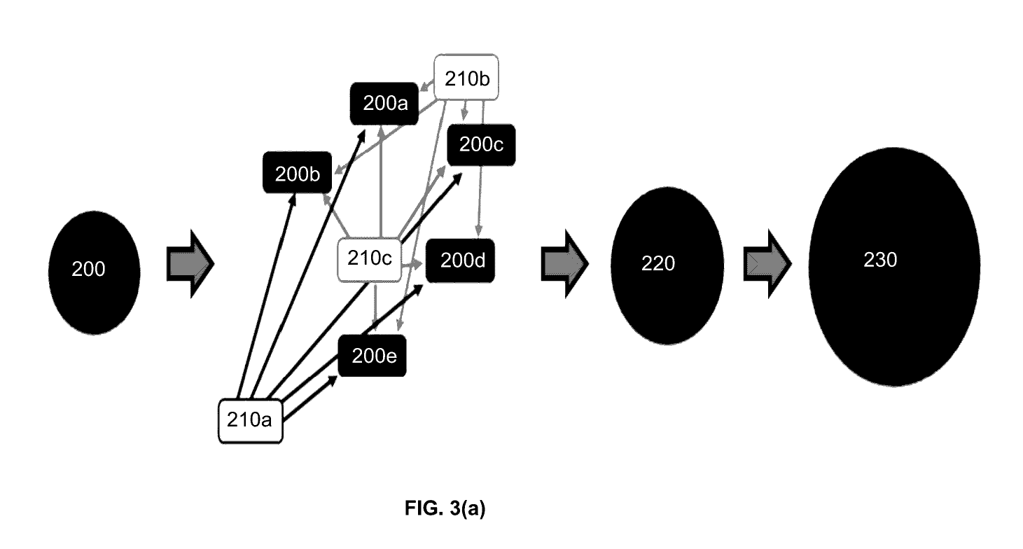

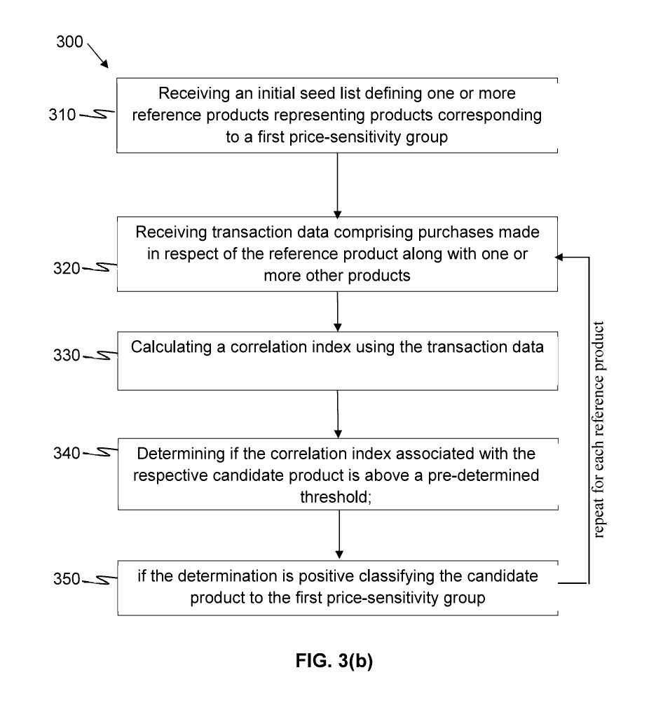

FIGS. 3(a) and 3(b) show an exemplary method 300 according to another embodiment. The method 300 is for classifying products based on their price-sensitivities. Similarly, this method 300 may be implemented by a computer system such as one described in FIG. 2. A skilled person would understand that the technical architecture 100 can be readily adapted for performing the method 300. The embodiments below are illustrated with reference to transaction data describing transactions carried out with grocery stores. It will be understood that the invention is not limited to such merchants or retail sectors.

At step 310, a seed list 200 containing a plurality of products is provided. For example, the initial seed list 200 comprises 100 different products (“seed items”) 200a, 200b, 200c, 200d, 200e etc. (for illustration purposes FIG. 3(a) only shows 5 products). The seed items 200a, 200b, 200c, 200d, 200e are products have known price-sensitivity scores corresponding to a particular price-sensitivity group, such as a high-price-sensitivity group characterized by being mostly frequently purchased by price-sensitive consumers. The seed list 200 may be created by a merchant or a specialist who has knowledge of products belonging to a particular sensitivity group. For example, the seed item 200a is a lifebuoy soap bar (which has a product with a high price-sensitivity score in India). Accordingly to one particular example, the price-sensitivity score of each of the individual seed items 200a, 200b, 200c, 200d, 200e is known, and they are used for determining a price-sensitivity score of other products.

For each of the seed items 200a, 200b, 200c, 200d, 200e, steps 320-350 will be performed as illustrated below. At steps 320-330, transaction data will be analysed to identify products which were purchased together with one or more of the seed items 200a, 200b, 200c, 200d, 200e. For example, a plurality of products 210a, 210b, 210c may be identified, which were purchased together with the seed item 200a, 200b, 200c, 200d, 200e in the transactions with the grocery store. In this example, the product 210a is bought with the seed item 200a in a single transaction by a consumer. The product 210a is also found to have been bought with both of the seed items 200b, 200c in another single transaction. The product 210a is also found to have been bought by a same consumer who has bought the seed items 200d, 200e in an earlier transaction. This suggests a correlation between purchases the product 210a and the seed items 200a, 200b, 200c, 200d, 200e, or even the seed list 200 as a whole. A correlation index indicative of such a correlation may be determined for the product 210a, and similarly for the products 210b, 210c. At step 340, a price-sensitivity score for the products 210a, 210b, 210c can be calculated using the respective correlation index and the price-sensitivity score for the seed items 200a, 200b, 200c, 200d, 200e or even price-sensitivity score associated with the seed list 200 as a whole. In the example illustrated by FIG. 3(a), all of the products 210a, 210b, 210c exhibits a strong correlation (e.g. association) with the seed list 200 through the correlation with the seed items 200a, 200b, 200c, 200d, 200e.

By running through the SKU level transaction data, the method 300 will identify products which have maximum correlation (e.g. most frequently bought together) with the seed items. The identified products may then be classified as having a similar level of price-sensitivity as the seed items and may be aggregated together to form an updated seed list 220. For example, the number of the seed items may grow to 500 products after one iteration. The process may be iteratively carried out to aggregate more products having a similar price-sensitivity score to form a final product list 230 containing products belong to a certain price-sensitivity group.

Typically, the first iteration will be able to fetch products with strongest associations with the seed items. As a number of iterations are performed, the strength of the association will diminish. To more accurately account for this, a weight factor may be employed which decreases as the number of iterations increases so as to compensate for a weaker correlation. The iterative process may be terminated once the seed list has reached a certain size, or upon a pre-determined number of iterations have been performed. As the correlation becomes weaker and weaker, it will no longer be meaningful to repeat the process exhaustively.

A second seed list representing products corresponding to a different price-sensitivity group, such as up-market products, is also provided and the method 300 runs to extract a group of products having a similar level of price-sensitivity as the seed items defined in the second seed list. A third seed list containing seed items belonging to average price-sensitivity level may also be used to obtain a list of other products of an average price-sensitivity.

In a further embodiment, a price-sensitivity rating for a consumer can be calculated using a computer system having a technical architecture such as one described in FIG. 2. The method includes receiving transaction data representing a past transaction performed by a consumer, and the transaction data comprises one or more products of a purchase. The method further includes receiving price-sensitivity data associated with the one or more products of a purchase, and calculating a price-sensitivity rating for the consumer using the price-sensitivity data which is indicative of a price-sensitivity level of the consumer.

The method may further comprise generating and transmitting targeted offers and/or advertisement material to the consumer based on the price-sensitivity rating of the consumer, the target offers and/or advertisement material comprising one or more products selected based on the price-sensitivity rating.

In some embodiments, the price-sensitivity data comprises a price-sensitivity score of the product obtained by a method described above. In one example, the price-sensitivity data comprises a price-sensitivity group associated with the product obtained by a method described above.

In yet a further embodiment, a price-efficiency rating can be calculated for a merchant. The method comprises operations of receiving transaction data representing past transactions performed by a plurality of consumers with a merchant; receiving a price-sensitivity sensitivity rating associated with the each of the plurality of consumers; and calculating a price-efficiency rating for the merchant using the price-sensitivity data, which is indicative of a price-efficiency level of the merchant in respect of goods for sale or service for hire.

According to a particular example, the method further comprises obtaining a price-efficiency rating for each of a plurality of merchants. The method further includes selecting a subset of the plurality of merchants based on the respective price-efficiency ratings, and generating and transmitting offers and/or advertisement material associate with the subset of merchants.

In some embodiments, the operation (f) comprises transmitting the offers and/or advertisement material to a subset of the plurality of consumers. The subset of merchants may comprise merchants associated with different retail sectors. In some embodiments, the subset of merchants comprises a retailer for goods and a retailer for service.

In yet a further embodiment, a price-sensitivity score associated with a single transaction (i.e. a “basket”) may be obtained using the price-sensitivity scores of the products purchased in that transaction.

### Advantages and Industrial Applications of Embodiments of the Present Invention

The benefit of understanding the price sensitivity or price efficiency of products, customers, and merchants is vast. In particular, products relating to pricing solution management can be created with this tool. The below provides some specific examples.

1. Store level price optimization compared to local competition

Since a price-sensitivity profile of consumers visiting a particular retail store can be obtained using the method, then the prices of each product can be managed to such as to appeal to the consumers. For example, products which are more important (e.g. more price-efficient) to price-sensitive consumers should be priced lower than competition and vice versa.

2. Targeted customer communication or advertising

A merchant might send different advertising materials or different offers to consumers, depending on their price sensitivity. Similarly, advertising campaign may send targeted offer and advertisement material from selected merchants to a consumer, based on the merchants' price-efficiency level.

3. Product launch support

Since the price profile of customers by store, region, etc. can be obtained by the method, an estimation of the demand for a new product launch can be made more accurately since the pricing factor of the product can be accounted for. For example, if a manufacturer is launching a niche and expensive product, it is important to find out a number of potential consumers by regions whose profiles match that of the product.

4. Benchmarking of pricing profile of customers

Since each consumer's price-sensitivity profile can be determined by the method, it is possible for merchants or retailers to benchmark their consumers' profiles against others, for example, the proportion of price-sensitive and upmarket consumers a merchant has as compared to the demographic average in a region. This may be done at a retailer level for all of its products, or may be done for a specific product category such as dairy, bread, fresh fruits & vegetables, etc.

5. Price-profile vis-à-vis that of local competition

Since the price-sensitivity of products can be obtained by the method, a store will also able to benchmark the price-profile of products of a certain price-sensitive level (e.g. price-sensitive products) against that of the demographic average in a region.

6. Understand customer perception of a merchant regarding pricing

A consumer's behavior across merchants may be studied. For a retailer A, we can analyze whether its consumers in a category use it for buying price-sensitive products whereas the consumers may be using another retailer for upmarket products. For example, a consumer may buy regular meat products for regular consumption from Tesco, while he may buy a higher grade of meat products from Waitrose.

7. Extrapolation to non-grocery sector merchants

For merchants in non-grocery sectors, for example, those in departmental stores, travel and hospitality, apparels, etc., it is usually difficult to directly assess price sensitivity based on purchase behavior due to small baskets, low transaction frequency, etc. However, if we assume that a consumer who is price-sensitive in grocery is also price-sensitive in the other sectors of retail, then even a merchant in other sectors may use this consumer information to design campaigns or products accordingly.

Moreover, it is also made possible to estimate a price-efficiency level of the merchants, regardless of which retail sector the merchant belongs to. Since the present method allows a consumer's price-sensitivity rating to be determined, the merchant's price efficiency rating may be estimated based on the price-sensitivity rating of consumers who had carried out transactions with the merchant.

Whilst the foregoing description has described exemplary embodiments, it will be understood by those skilled in the art that many variations of the embodiment can be made within the scope and spirit of the present invention. For example, the price-efficiency rating may be computed for a service provider. For another example, the price-sensitivity scores of the products may be determined at regular time intervals to account for price fluctuations due to seasonal factors. Consequently, this may result in a change in the price-sensitivity level or category (such as the category of initial seed items) of the product. For example, seasonal products like fresh strawberries might be in the list of price sensitive products in summer, but they may become up-market products in winter months.

1. A computer-implemented method for computing a price-efficiency rating for a merchant, the method comprising operations of:
(a) receiving, by a transaction analysis component, transaction data representing past transactions performed by a plurality of consumers with a merchant;
(b) receiving, by a consumer analysis component, a price-sensitivity rating associated with the each of the plurality of consumers; and
(c) calculating, by the transaction analysis component, a price-efficiency rating for the merchant using the price-sensitivity rating data; said price-efficiency rating being indicative of a price-efficiency level of the merchant in respect of goods for sale or service for hire.

2. A computer-implemented method according to claim 1 further comprising:
(d) obtaining a price-efficiency rating for each of a plurality of merchants;
(e) selecting a subset of the plurality of merchants based on the respective price-efficiency ratings; and
(f) generating and transmitting offers and/or advertisement material associated with the subset of merchants.

3. A computer-implemented method according to claim 2, wherein operation (f) comprising transmitting the offers and/or advertisement material to a subset of the plurality of consumers.

4. A computer-implemented method according to claim 2, wherein the subset of merchants comprises merchants associated with different retail sectors.

5. A computer-implemented method according to claim 2, wherein the subset of merchants comprises a retailer for goods and a retailer for service.

6. A computer-implemented method according to claim 1, wherein the price-sensitivity rating for a first of the plurality of consumers is obtained by:
(a) receiving, by the transaction analysis component, transaction data representing a past transaction performed by the first consumer, said transaction data comprising one or more products of a purchase;
(b) receiving, by the product analysis component, price-sensitivity data associated with the one or more products; and
(c) calculating, by the transaction analysis component, a price-sensitivity rating for the first consumer using the price-sensitivity data; said price-sensitivity rating being indicative of a price-sensitivity level of the first consumer.

7. A computer-implemented method according to claim 6, wherein the price-sensitivity data comprising a price-sensitivity score for a first of the one or more products, the price-sensitivity score for the first product obtained by:
(a) receiving, by the transaction analysis component, transaction data comprising a purchase of the first product by the first consumer;
(b) receiving, by the product analysis component, a reference price-sensitivity score for a reference product for sale;
(c) calculating, by the transaction analysis component, a correlation index using the transaction data; said correlation index being indicative of a correlation between purchases of the first product and the reference product; and
(d) calculating, by the product analysis component, the price-sensitivity score for the first product using the correlation index and the reference price-sensitivity score.

8. A computer-implemented method according to claim 7, wherein the correlation index is indicative of a number of transactions in which the reference product and the first product are purchased in a single transaction.

9. A computer-implemented method according to claim 7, wherein the correlation index is indicative of a frequency of transactions in which the reference product and the first product are purchased in a single transaction.

10. A computer-implemented method according to claim 7, wherein the correlation index is indicative of a likelihood of the reference product and the first product being purchased by a same consumer.

11. A computer-implemented method according to claim 7, wherein the correlation index is indicative of a likelihood of the reference product and the first product being respectively purchased in related transactions, the related transactions defining transactions associated with a common product.

12. A computer-implemented method according to claim 11, wherein the related transactions comprise purchases of a same product.

13. A computer-implemented method according to claim 7, wherein the reference product and the first product are associated with different retail sectors.

14. A system for computing a price-efficiency rating for a merchant, said system comprising:
a computer processor and a data storage device, the data storage device having a transaction analysis component and a product analysis component comprising non-transitory instructions operative by the processor to,
(a) receive, by a transaction analysis component, transaction data representing past transactions performed by a plurality of consumers with a merchant;
(b) receive, by a consumer analysis component, a price-sensitivity sensitivity rating associated with the each of the plurality of consumers; and
(c) calculate, by the transaction analysis component, a price-efficiency rating for the merchant using the price-sensitivity data; said price-efficiency rating being indicative of a price-efficiency level of the merchant in respect of goods for sale or service for hire.

15. A system according to claim 14, wherein the non-transitory instructions further operative by the processor to,
(d) obtain a price-efficiency rating for each of a plurality of merchants;
(e) select a subset of the plurality of merchants based on the respective price-efficiency ratings; and
(f) generate and transmit offers and/or advertisement material associated with the subset of merchants.

16. A system according to claim 15, wherein operation (f) further comprising transmitting the offers and/or advertisement material to a subset of the plurality of consumers.

17. A system according to claim 15, wherein the subset of merchants comprises merchants associated with different retail sectors.

18. A system according to claim 15, wherein the subset of merchants comprises a retailer for goods and a retailer for service.

19. A system according to claim 14, wherein the non-transitory instructions are further operative to obtain the price-sensitivity rating for a first of the plurality of consumers by:
(a) receiving, by the transaction analysis component, transaction data representing a past transaction performed by the first consumer, said transaction data comprising one or more products of a purchase;
(b) receiving, by the product analysis component, price-sensitivity data associated with the one or more products; and
(c) calculating, by the transaction analysis component, a price-sensitivity rating for the first consumer using the price-sensitivity data; said price-sensitivity rating being indicative of a price-sensitivity level of the first consumer.

20. A system according to claim 19, wherein the price-sensitivity data comprising a price-sensitivity score for a first of the one or more products, the non-transitory instructions are further operative to obtain the price-sensitivity score for the first product by:
(a) receiving, by the transaction analysis component, transaction data comprising a purchase of the first product by the first consumer;
(b) receiving, by the product analysis component, a reference price-sensitivity score for a reference product for sale;
(c) calculating, by the transaction analysis component, a correlation index using the transaction data; said correlation index being indicative of a correlation between purchases of the first product and the reference product; and
(d) calculating, by the product analysis component, the price-sensitivity score for the first product using the correlation index and the reference price-sensitivity score.

21. A system according to claim 20, wherein the correlation index is indicative of a number of transactions in which the reference product and the first product are purchased in a single transaction.

22. A system according to claim 20, wherein the correlation index is indicative of a frequency of transactions in which the reference product and the first product are purchased in a single transaction.

23. A system according to claim 20, wherein the correlation index is indicative of a likelihood of the reference product and the first product being purchased by a same consumer.

24. A system according to claim 20, wherein the correlation index is indicative of a likelihood of the reference product and the first product being respectively purchased in related transactions, the related transactions defining transactions associated with a common product.

25. A system according to claim 24, wherein the related transactions comprise purchases of a same product.

26. A system according to claim 20, wherein the reference product and the first product are associated with different retail sectors.

27. A non-transitory computer-readable medium for computing a price-efficiency rating for a merchant, having stored thereon program instructions for causing at least one processor to,
(a) receive, by a transaction analysis component, transaction data representing past transactions performed by a plurality of consumers with a merchant;
(b) receive, by a consumer analysis component, a price-sensitivity sensitivity rating associated with the each of the plurality of consumers; and
(c) calculate, by the transaction analysis component, a price-efficiency rating for the merchant using the price-sensitivity data; said price-efficiency rating being indicative of a price-efficiency level of the merchant in respect of goods for sale or service for hire.

28. A system according to claim 27, wherein the program instructions further operative for causing the at least one processor to,
(d) obtain a price-efficiency rating for each of a plurality of merchants;
(e) select a subset of the plurality of merchants based on the respective price-efficiency ratings; and
(f) generate and transmit offers and/or advertisement material associated with the subset of merchants.

29. A non-transitory computer-readable medium according to claim 28, wherein operation (f) further comprising transmitting the offers and/or advertisement material to a subset of the plurality of consumers.

30. A non-transitory computer-readable medium according to claim 28, wherein the subset of merchants comprises merchants associated with different retail sectors.

31. A non-transitory computer-readable medium according to claim 28, wherein the subset of merchants comprises a retailer for goods and a retailer for service.

32. A non-transitory computer-readable medium according to claim 27, wherein the program instructions are further operative for causing the at least one processor to obtain the price-sensitivity rating for a first of the plurality of consumers by:
(a) receiving, by the transaction analysis component, transaction data representing a past transaction performed by the first consumer, said transaction data comprising one or more products of a purchase;
(b) receiving, by the product analysis component, price-sensitivity data associated with the one or more products; and
(c) calculating, by the transaction analysis component, a price-sensitivity rating for the first consumer using the price-sensitivity data; said price-sensitivity rating being indicative of a price-sensitivity level of the first consumer.

33. A non-transitory computer-readable medium according to claim 32, wherein the price-sensitivity data comprising a price-sensitivity score for a first of the one or more products, the program instructions are further operative for causing the at least one processor to obtain the price-sensitivity score for the first product by:
(a) receiving, by the transaction analysis component, transaction data comprising a purchase of the first product by the first consumer;
(b) receiving, by the product analysis component, a reference price-sensitivity score for a reference product for sale;
(c) calculating, by the transaction analysis component, a correlation index using the transaction data; said correlation index being indicative of a correlation between purchases of the first product and the reference product; and
(d) calculating, by the product analysis component, the price-sensitivity score for the first product using the correlation index and the reference price-sensitivity score.

34. A non-transitory computer-readable medium according to claim 33, wherein the correlation index is indicative of a number of transactions in which the reference product and the first product are purchased in a single transaction.

35. A non-transitory computer-readable medium according to claim 33, wherein the correlation index is indicative of a frequency of transactions in which the reference product and the first product are purchased in a single transaction.

36. A non-transitory computer-readable medium according to claim 33, wherein the correlation index is indicative of a likelihood of the reference product and the first product being purchased by a same consumer.

37. A non-transitory computer-readable medium according to claim 33, wherein the correlation index is indicative of a likelihood of the reference product and the first product being respectively purchased in related transactions, the related transactions defining transactions associated with a common product.

38. A non-transitory computer-readable medium according to claim 37, wherein the related transactions comprise purchases of a same product.

39. A non-transitory computer-readable medium according to claim 33, wherein the reference product and the first product are associated with different retail sectors.

40-79. (canceled)
